(19) United States
(12) Patent Application Publication
(10) Pub. No.: US 2021/0386237 A1
(43) Pub. Date: Dec. 16, 2021

(54) BEVERAGE POD

(71) Applicant: Nexe Innovations Inc., Surrey (CA)

(72) Inventors: Darren Joseph Footz, Surrey (CA); Kianoush Karimi Pour Kerman, Vancouver (CA)

(21) Appl. No.: 17/344,541

(22) Filed: Jun. 10, 2021

Related U.S. Application Data
(60) Provisional application No. 63/037,422, filed on Jun. 10, 2020.

(51) Int. Cl. A47J 31/06

(52) U.S. Cl. CPC A47J 31/0689

(57) ABSTRACT

A beverage pod can include an outer shell which has a breakaway bottom. When a brewing pin from a beverage brewing machine impacts the breakaway bottom, at least a portion of the breakaway bottom can separate from the outer shell, and the brewing pin can be received by the breakaway bottom. The breakaway bottom can then abut and displace at least a portion of the filter, and/or the breakaway bottom separating from the outer shell can create an outlet through which beverage can be extracted.

### CROSS-REFERENCE TO RELATED APPLICATION(S)

This application claims priority benefit to U.S. Provisional Patent Application No. 63/037,422, filed in the U.S. Patent and Trademark Office on Jun. 10, 2020, which is incorporated herein by reference in its entirety for all purposes.

### FIELD

The present disclosure relates to a beverage pod such as, for example, a compostable beverage pod for single-serve use. The present disclosure further relates to the beverage cartridges or pods for use in single serving beverage brewing machines, for example beverage pods that are biodegradable.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Single-serve beverage pods have become a dominant method for serving beverages, especially hot beverages, in a variety of settings such as homes, offices, waiting rooms, hotel rooms and lobbies, and other places where people consume beverages. The rapid growth of single-serve beverage pods is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location or locations of origin, etc.

The convenience and variety of single serving beverage pods allows and encourages consumers to prepare and consume a plurality of beverages throughout the day. This pattern of consumption causes the rapid accumulation of used beverage pods wherever they are consumed. Due to the nature of single-serving beverage pods, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines outer shells and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

### BRIEF DESCRIPTIONS OF THE DRAWINGS

FIG. 1A illustrates an example beverage brewing system.

FIG. 1B illustrates an example of a conventional beverage pod.

FIG. 1C illustrates a schematic view of a portion of a beverage brewing machine.

FIG. 2 illustrates a cross-sectional view of a beverage pod with a breakaway bottom.

FIG. 3 illustrates the beverage pod of FIG. 2 with the breakaway bottom receiving a brewing pin and separating from an outer shell.

FIG. 4 illustrates a perspective view of an exemplary outer shell of a beverage pod.

FIG. 5 illustrates a side view of the beverage pod of FIG. 4.

FIG. 6 illustrates a cross-sectional view along 6-6 of FIG. 5.

FIG. 7 illustrates a top, perspective view of FIG. 4.

FIG. 8 illustrates an enlarged view of a portion of FIG. 6.

FIG. 9 illustrates an enlarged view of a portion of FIG. 7.

FIG. 10 illustrates a flow chart of a method for brewing a beverage according to the disclosure herein.

### DETAILED DESCRIPTION

Disclosed herein is a single-serving beverage pod that increases and/or maximizes the amount of beverage material and can increase the amount of beverage extracted from the beverage pod. The beverage pod can include an outer shell which has a breakaway bottom. The breakaway bottom can be integral with the outer shell. When the brewing pin impacts the beverage pod, at least a portion of the breakaway bottom can separate from the outer shell. The brewing pin is received by the breakaway bottom. In some examples, the breakaway bottom can then abut and displace at least a portion of the filter. The filter can then be increased such that more beverage material can be disposed in the beverage pod, as the brewing pin does not interact directly with and/or damage the filter. In some examples, the breakaway bottom separating from the outer shell creates an outlet through which beverage can be extracted.

Single-serve beverage pods can include several components made of various materials. For example, the components of a single-serve beverage pod can include, at least, an outer shell, for example made from plastic such as polyethylene, a filter, for example made from plant fiber such as abaca fibers or other natural and synthetic fibers, and a outer shell lid, for example made from food-grade aluminum foil, which is also commonly printed upon to include product labelling. Some beverage pods do not contain a filter because the beverage material is readily soluble in hot water (such as, for example, hot cocoa). The outer shell can include an opening on the top of the outer shell, and a hollow cavity within which and across which a filter may be disposed. The outer shell may also include an opening at on the bottom outer shell. After the filter and beverage material are inserted into the outer shell, the lid is then typically sealed over the outer shell opening or openings. The sealed lid typically provides an airtight seal, preventing the exchange of gases between the environment and the interior of the outer shell, thus preventing oxidation and/or spoilage of the beverage material. In beverage pods that comprise a filter, the filter may separate the outer shell into two chambers: a first chamber occupying the space within the outer shell between the filter and the opening of the outer shell, the first chamber for holding dry beverage ingredients such as, but not limited to, coffee, tea, or cocoa, for a single beverage serving; and a receiving portion occupying the space within the outer shell between the filter and the bottom of the outer shell, the receiving portion being on the opposite side of the filter to the first chamber.

The purpose of the receiving portion is typically to provide a space in which a fluid extractor of a beverage brewing device may be inserted into the bottom of the outer shell, entering the receiving portion and allowing the extraction of fluid from the pod without the fluid extractor entering the first chamber, such that fluid must flow through the beverage material and the filter before exiting the pod via the fluid extractor. However, the presence of the second chamber may significantly reduce the space within the outer shell that can be occupied by beverage material. This may be problematic as the total amount of beverage material disposed within the outer shell may significantly contribute to the final concentration of the beverage, typically measured in Total Dissolved Solids (TDS). It may be advantageous to minimize the volume of the second chamber in order to maximize the volume on the third chamber, thereby maximizing the total volume available for beverage material. However, the fluid extractor is typically comprised of a sharp, hollow needle-like piercing element designed to easily pierce through the bottom of the outer shell, such that if the second chamber is reduced in size, the fluid extractor may penetrate or damage the filter, allowing the beverage material to exit the first chamber, and ultimately exit the pod via the fluid extractor. Thus, in the event the fluid extractor penetrates or damages the filter, the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

The lid is disposed over the opening of the outer shell (which may be, for example, over the top of the outer shell, and/or bottom of the outer shell), and keeps the dry beverage ingredients within the outer shell, as well as providing an airtight seal to prevent the oxidation and other types of degradation of the outer shell's contents. In practice, a single-serving beverage pod is placed into a compartment of a brewing machine. The machine is activated such that a fluid injector penetrates the cover of the pod and a fluid extractor penetrates the base of the pod (which may also be a cover). The fluid injector injects a brewing medium (e.g. hot water) into the first chamber for extracting beverage components from the ingredients. The brewing medium containing the extracted beverage components percolates through the filter and into the second chamber. The brewing medium containing the extracted or dissolved beverage is then extracted by the fluid extractor and finally dispensed as a drinkable beverage.

Conventionally, the outer shell of a beverage pod for single-serve use is typically made from petroleum-based plastic materials which are neither biodegradable nor compostable. In some cases, the outer shell may be made of petroleum biodegradable materials, such as Polybutylene adipate terephthalate (PBAT). While these materials may eventually biodegrade, they are not desirable for use in home or industrial composting settings, as they may pollute the compost with petroleum residue, microplastics, and other chemicals that may not be desirable for compost. Composting is the mixing of various decaying organic substances, such as dead plant matter, which are allowed to decompose to the point that various waste products of the composting process provide nutrients to be used as soil conditioners/fertilizers. Composting can be aerobic, anerobic, and/or vermicomposting, depending on the environment in which the compost is prepared. Aerobic composting is the decomposition of organic matter by microbes that require oxygen to process the organic matter. The oxygen from the air diffuses into the moisture that permeates the organic matter, allowing it to be taken up by the microbes. Anerobic composting is the decomposition of organic matter by microbes that do not require oxygen to process the organic matter. To be anerobic, the system must be sealed from the air, such as with a plastic barrier. Anerobic compositing produces an acidic environment to digest the organic material. Vermicomposting is the decomposition of organic matter by worms and other animals (such as soldier flies). A portion of the organic matter is converted to vermicast, or castings from the worms or other animals. The breakdown of the organic matter into vermicast yields an effective soil conditioner and/or fertilizer.

The lid of a beverage pod can be made of a polypropylene and a metal foil (e.g., aluminum) or a metal foil laminate which is affixed to the top of the outer shell with thermal welding or some other means (e.g. adhesives). Generally, neither the metal foil of the cover nor the glue affixing the cover over the opening of the outer shell is biodegradable, compostable, or made from readily renewable resources. As a result, non-biodegradable and non-compostable beverage pods typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process may be partially automated; however, it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage outer shells, such as instant beverage cups or pods, can be particularly difficult to recycle. Not only do they have non-recyclable material contained within them that would first need to be removed, they are frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling; however, this inconvenience will inevitably result in consumers recycling the beverage outer shells without proper preparations, or failing to recycle the outer shell at all, electing to discard the outer shell as trash. One of the major advantages of using beverage pods is consumer convenience, such that a beverage can be prepare by simply inserting a pod into a machine that performs all other brewing functions. It is therefore undesirable to instruct consumers to disassemble and sort various materials from the beverage pod, and due to the diminutive size of beverage pods, this may not be physically possible for consumers without fine motor skills necessary to disassemble such an item. The result is a required step of preprocessing the outer shells before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Other chemicals that can be found in plastics include thalates, antiminitroxide, brominated flame retardants and poly-fluorinated chemicals. Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or bioplastics, which originate from biomass, are biodegradable. Only a small subset of these are also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from microplastics, as the plastic molecules themselves do not degrade any faster than their traditional plastic counterparts. There have been efforts in some jurisdictions to ban these plastics.

Beverage pods, also known as cartridges, capsules, etc., for use with beverage forming machines may include one or more filters as well as a beverage material, such as ground coffee beans, tea leaves, etc. In some beverage pods, the filter can be located between two or more portions of an interior space of the cartridge, e.g., one portion in which a beverage material is located, and a second portion into which liquid that has passed through the filter may flow. In use, the beverage forming machine introduces a fluid into the beverage pod to interact with the beverage material. In some machines, a brewing pin of the machine is used to pierce and/or breach a surface of the beverage pod (e.g., a bottom wall of the beverage pod) permitting the liquid that has interacted with the beverage material to flow through the filter and exit the beverage pod. However, the brewing pin of the beverage machine entering the interior of the beverage pod can present significant limitations on the total amount of beverage material which can be placed in the beverage pod. If the brewing pin comes into contact with the filter material, several adverse effects may occur, such as damaging the filter material, allowing beverage material to flow without filtration into the final beverage, damming, and/or agglomeration may occur. For example, the filter material in contact with the brewing pin of a beverage machine may prevent flow of liquid into the final beverage.

A conventional solution to this problem is to create a filter such that the bottom of the filter is raised above the bottom wall, such that the brewing pin cannot come into contact with the filter material. However, shortening the filter as such significantly reduces the volume of beverage material which may be placed in the filter, such reduction may, in some cases, reduce the strength of flavor for a beverage of a given size, or may lower the size of a beverage that can be produced at a given strength of flavor. This is not ideal for specialty beverages, such as coffee, tea, hot cocoa, and other beverages, which rely on a superior flavor and strength thereof to satisfy customer organoleptic perception compared to brewing beverages by traditional means.

Alternative solutions exist to prevent the brewing pin from contacting the filter material. One solution is the introduction of a filter guard. A filter guard is a device comprised of rigid plastic which is placed above or below the filter material. If provided below the filter material (e.g., between the filter and the bottom wall of the beverage pod), the filter guard may resist damage to the filter from the piercing element, allowing the filter to deform instead, producing enough space for the filter element without damaging the filter. If placed above the filter material (e.g., within the chamber formed by the filter material), the piercing element may be allowed to damage the filter material, but in such a way as to prevent the beverage material from flowing out of the cartridge unfiltered. Both of these solutions can suffer from an additional problem, which is the addition of material which is rigid and often thicker than other materials in the beverage pod, increasing cost of manufacture, and/or, in the case of compostable materials, delaying the speed of decomposition of the beverage pod. There exists a need to produce protection for the filter and/or beverage material, without the need to introduce additional materials, devices, and or construction steps to the beverage pod.

The present disclosure allows the additional beverage material volume to be added to the beverage pod without risking damage to the filter material and without adding the need for a discrete device, such as a rigid filter guard that is placed in conventional beverage pods.

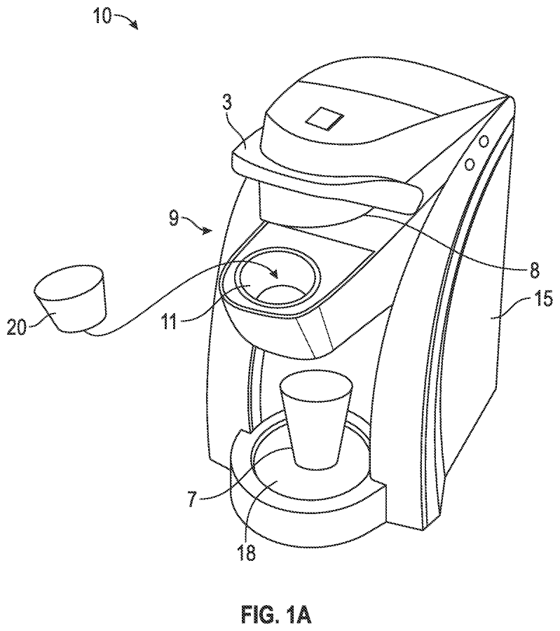

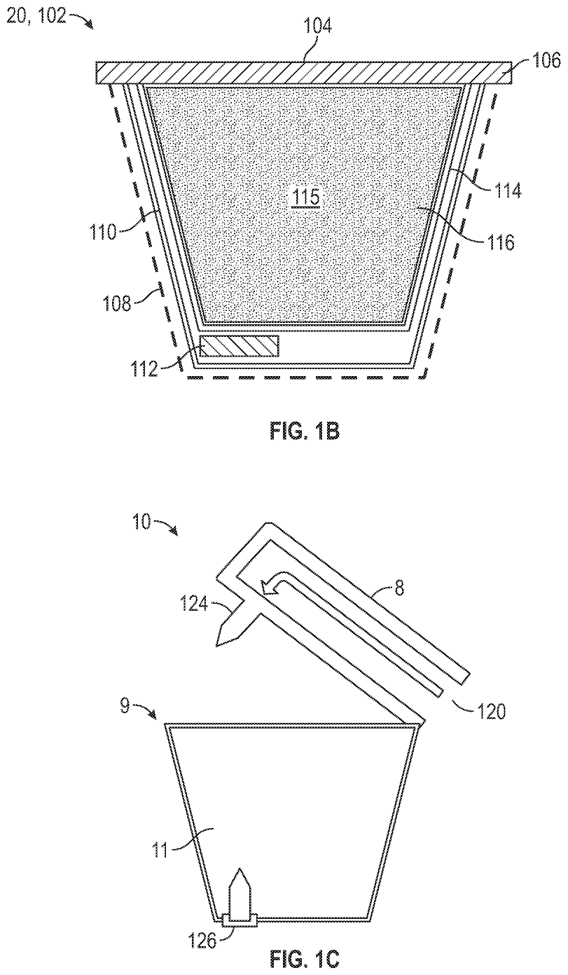

FIG. 1A illustrates a beverage brewing system 10 operable to brew a beverage. The beverage brewing system 10 includes a beverage brewing machine 3 and a beverage pod 20. The beverage brewing machine 3 is operable to receive the beverage pod 20 and may be used to form any suitable beverage, such as tea, coffee, or other infusion-type beverages. Beverages may be formed from a liquid and/or dry materials, for example to make soups, juices or other beverages made from dried materials, other materials. The beverage brewing machine 3 can create a beverage that is deposited into a user's cup 7. In at least one example, the user can position the cup 7 onto a platform 18. In some examples, the user may position the cup 7 on a table top. The beverage pod 20 can be inserted into a pod holder 9 which has a brewing chamber 11 operable to receive the beverage pod 20. In at least one example, the beverage pod 20 may be manually or automatically placed in the pod holder 9. A cover 8 can at least partially cover the brewing chamber 11 to at least partially enclose the beverage pod 20 in the pod holder 9 in which the beverage pod 20 is used to make a beverage.

FIG. 1B illustrates a beverage pod 20, for example an example of a conventional beverage pod 102. Beverage pods 102, or beverage cartridges, are outer shells, pods, capsules, etc., for use in the beverage brewing machine 3, such as a coffee maker. The beverage pod 20 may include one or more of, a beverage material 116 that is either soluble or insoluble, one or more filters 114, and a first portion 115 in which liquid is passed into and a second portion 112 through which liquid passes out of the beverage pod 20. In some examples, the beverage pods 20 can be portioned beverage packages that can contain a water-soluble material, to make a drink such a hot chocolate, chai tea, etc. These portioned packages can be pouches as well as pods for beverage brewing machines 3.

The beverage pod 102 can contain a number of components, including lid 104. The lid 104 is operable to close the beverage pod 102 to contain the beverage material 116 in the first portion 115. The lid 104 can be made of, for example, a foil that is sealed to the beverage pod 20 so as to contain the beverage material 116. A compostable lid 104 may be comprised of, for example a spun bond PLA web film (which may contain, for example, a proportion of PHA), a cellulose paper film, etc. The pod bond 106 is the connection between any two of the lid 104, outer shell 108, and/or pod interior 110. The pod bond 106 can be mechanical or chemical, and such as adhesives, heat sealing, ultrasonic welding, etc. The pod bond 106 can be in one place or separately depending upon the use case. The pod bond 106 can include a filter bond that binds the filter medium to a portion of the beverage pod 20, such as by ultrasonic welding, adhesives, thermal sealing, etc.

A outer shell 108 is the outer shell of the beverage pod 20. The exterior 108 can be made of plastic (especially compostable plastic, such as PLA, PHA, or combinations thereof), cellulose, etc. The outer shell 108 can have similar properties to other thermoplastic polymers such as polypropylene (PP), polyethylene (PE), or polystyrene (PS). This allows it to serve as a biodegradable alternative for coffee pods. In some examples, the outer shell 108 can also be made from polyhydroxyalkanoates (PHAs), which are a biodegradable polyester produced through bacterial fermentation of sugar or lipids. The outer shell 108 can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage pod 20. PLLA is also readily renewable, typically made from fermented plant starch such as from corn, cassava, sugarcane, or sugar beet pulp. Cellulose fibers are fibrous materials made from plant materials such cotton, flax, wood pulp, etc. Cellulose fibers can provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH), and/or Polybutylene adipate terephthalate (PBAT).

In some examples, beverage pods 20 can also contain a pod interior 110 that is separate from a filter 114, in beverages that have an insoluble beverage material such as coffee. The pod interior 110 can be used for a number of purposes, including, providing material properties such as structural integrity (e.g., provide addition strength to resist the pressure of liquid injection in the process of brewing a beverage, which may crack or otherwise compromise the beverage pod 20), and/or altering the biodegradability or rate of the beverage pod 20. A registration element 112, or faceplate, is a solid structure integrated into a beverage pod 20 that prevents the brewing pin 126 (shown in FIG. 1C) from creating a path for the insoluble beverage material from inside the filter 114 to the outlet. In some examples, the pod interior 114 may include integrated features to act as a registration element 112, removing the requirement for a discrete component.

The filter 114 can be a medium, such as spun bond PLA web, paper (cellulose), cloth or metal, that is used to prevent an insoluble beverage material 116 from leaving the beverage pod 20 and entering the beverage brewing machine 3 or the beverage. Filters 114 can be symmetrical (e.g., fluted), or asymmetrical (e.g. pleated).

Beverage material 116 is the material used to produce a brewed beverage, such as coffee grounds, tea, or a mix beverage where the beverage material is soluble, such as hot chocolate. Beverage material 116 may include any flavorings, nutritional content (e.g., any oils, nutritional supplements, active ingredients such as pharmaceuticals, cannabinoids, etc.), alcohol, coloring, or any other composition which has an effect on the final beverage.

Referring to FIGS. 1A, 1B, and 1C, beverage brewing machines 3 for brewing portioned beverages from pre-packed beverage pods 20 exist for a variety of beverages made from a beverage material 116 that is either insoluble, such as coffee, or soluble, such as hot chocolate. A beverage brewing machine 3 can contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, the beverage brewing machine 3 contains all components necessary to accomplish the beverage brewing process, though specific reference to beverage brewing machine components may only be made to those components which come into direct contact with the beverage pod 20, such as the brewing chamber 11, a fluid injecting component 124, and a brewing pin 126. The beverage brewing machine 3 can contain a fluid source 120 that supplies the liquid, which may be water, to the brewing machine 3 for producing the desired beverage. A cover 8 can be opened to allow a new beverage pod 20 to be added to the beverage brewing machine 3. The beverage pod 20 can be received in the brewing chamber 11. In some examples, the cover 8 contacts the fluid source 120 to the fluid injecting component 124, but the fluid source 120 does not have to be provided in the cover 120. A fluid injecting component 124 can be operable to breach the lid 104 and be in fluid communication with the first portion 115. In some examples, the fluid injecting component 124 can include a piercing component to pierce the lid 104. The fluid injecting component 124 can provide a liquid, typically hot water, to mix with the beverage material 116 to create the beverage. A brewing pin 126 can be operable to breach the bottom of the beverage pod 20 to allow the brewed beverage to leave the beverage pod 20 and/or the brewing chamber 11. In some examples, the brewing pin 126 can be operable to breach the beverage pod 20 through the second portion 112. The second portion 112 may be located opposite the first portion 115 in relation to the filter 114 such that the beverage can be extracted without the beverage material 116. In some examples, the brewing pin 126 may pierce or deform other components of the beverage pod 20 to breach the beverage pod 20.

As shown in FIG. 1B, the conventional beverage pod 102 has a large receiving portion 160 disposed underneath the filter 114. The receiving portion 160 is disposed between the filter 114 and the bottom of the beverage pod 102. Conventionally, the filter 114 has a substantially flat bottom which is substantially parallel with the bottom of the beverage pod 102. Conventional beverage pods 102 leave such a large receiving portion 160 in order to prevent the brewing pin 126 from penetrating the filter 114. The brewing pin 126 can be fluidly coupled to an outlet through which the beverage can be deposited into the cup 7.

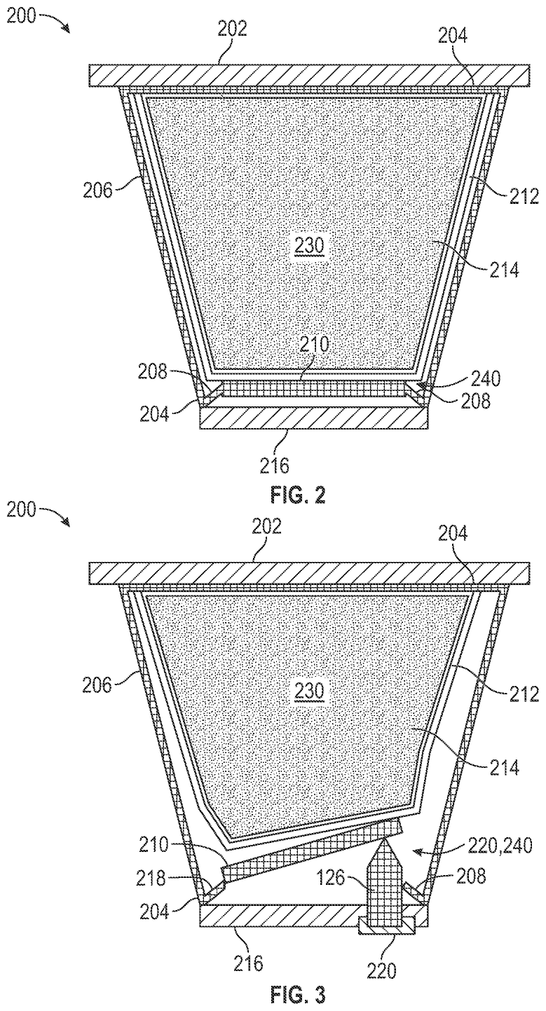

FIGS. 2 and 3 illustrate a beverage pod 200 that includes a breakaway bottom 210 that receives and/or abuts against the brewing pin 126 and pushes against the filter 212 to release the beverage through the filter 212 and out of the beverage pod 200. The beverage pod 200 includes a lid 202. In at least one example, the lid 202 can be made of foil, that is sealed to the beverage pod 200 via a pod bond (e.g. thermal bond) so as to contain the beverage material 214 within the beverage pod 200. A compostable lid 202 may be comprised of, for example a spun bond PLA web film (which may contain a proportion of PHA, in some embodiments), a cellulose paper film, etc. The lid 202 can be the liquid injection point, wherein a fluid injecting component 124 breaches the lid 202 and injects the brewing liquid. In at least one example, the lid 202 can include a cellulose film. The pod bond 204 is the connection between any two of the lid 202, the outer shell 206, and/or filter 212. The pod bond 204 can be thermal, mechanical, or chemical, and may comprise one or more of adhesives, heat sealing, ultrasonic welding, etc. The pod bond 204 may bond the filter 212 in the same place or separately depending upon the use case. The filter 212 can be bonded to a portion of the beverage pod 200, such as by ultrasonic welding, adhesives, thermal sealing, etc. In at least one example, the pod bond 204 can include an adhesive which bonds the cellulose film of the lid 202 to the PLA of the outer shell 206.

A filter 212 can be disposed in the outer shell 206 and can form a chamber 230 to contain a beverage material 214. The filter 212 can permit passage of fluid through the filter 212 while restricting passage of the beverage material 214. Accordingly, the beverage formed between the liquid and the beverage material 214 can pass through the filter 212 to the user's cup 7 without the beverage material 214 passing through. The filter 212 can include a medium, such as spun bond PLA web, paper (cellulose), cloth or metal, that can prevent an insoluble beverage material 214 from leaving the beverage pod 200 and entering the beverage brewing machine 10 or the beverage. Filters 212 can be symmetrical (e.g., fluted), or asymmetrical (e.g. pleated). In at least one example, the filter 212 can include a spun bond PLA web which is fused to the outer shell 206 and/or the lid 202 via a pod bond 204 and is protected from the brewing pin 126, for example by a breakaway bottom 210.

Beverage material 214 is the material used to produce a brewed beverage, such as coffee grounds, tea, or a mix beverage where the beverage material is soluble, such as hot chocolate. Beverage material 214 may include any flavorings, nutritional content (e.g., any oils, nutritional supplements, active ingredients such as pharmaceuticals, cannabinoids, etc.), alcohol, coloring, or any other composition which has an effect on the final beverage. In at least one example, the beverage material 214 can include coffee grounds which are contained within the chamber 230 formed by the filter 212.

In some examples, beverage pods 200 can also contain a capsule interior that is separate from a filter, in beverages that have an insoluble beverage material such as coffee. The pod interior can be used for a number of purposes, including, providing material properties such as structural integrity (e.g., provide addition strength to resist the pressure of liquid injection in the process of brewing a beverage, which may crack or otherwise compromise the beverage pod), or altering the biodegradability or rate of the beverage pod in some embodiments.

The outer shell 206 can be made of plastic (especially compostable plastic, such as PLA, PHA, or combinations thereof), cellulose, etc. The outer shell 206 can have similar properties to other thermoplastic polymers such as polypropylene (PP), polyethylene (PE), or polystyrene (PS). This allows it to serve as a biodegradable alternative for coffee pods. In some examples, the outer shell 206 can also be made from polyhydroxyalkanoates (PHAs), which are a biodegradable polyester produced through bacterial fermentation of sugar or lipids, and can be used as alternatives to other synthetic plastics. The mechanical properties of PHAs can be modified for a given use case by blending it with other biodegradable polymers, such as PLAs. The outer shell 206 can also be made from poly(L-lactide) (PLLA), which is a polymer that is also biodegradable and compostable. The material may be used to form various aspects of the beverage pod 200. PLLA is also readily renewable, typically made from fermented plant starch such as from corn, cassava, sugarcane or sugar beet pulp. Cellulose fibers are fibrous materials made from plant materials such cotton, flax, wood pulp, etc. They provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH) and Polybutylene adipate terephthalate (PBAT). Thermoplastic materials can be formed via a process of vacuum forming wherein the plastic material is heated and then pulled over a form and applying a vacuum through the form so that the plastic material is pressed around the form by the ambient air pressure. Alternatively, thermoplastics may be injected into a mold via injection molding. Forming of non-plastic materials such as fibers can be formed in a pressure mold. Heat may additionally be applied to aid drying. In at least one example, the outer shell 206 can be comprised of PLA and is formed via vacuum forming over a form in the shape of the negative space within the beverage pod 200.

The breakaway bottom 210 is a portion of the outer shell 206 integrated into a beverage pod 200 that prevents the brewing pin 126 from creating a path for the insoluble beverage material 214 to pass from inside the chamber 230 to the outlet 220 (e.g., hole formed in the outer shell 206 and/or via the brewing pin 126). In some examples, the beverage pod 200 may include integrated features to act as a breakaway bottom 210, removing the requirement for a separate, discrete component. For example, the breakaway bottom 210 and the outer shell 206 may be one piece. In at least one example, the breakaway bottom 210 can be comprised of the same material as the outer shell 206. The breakaway bottom 210 can be a portion of the outer shell 206. For example, the breakaway bottom 210 can be an integral portion of the outer shell 206 with structural changes at a break portion 208 so that at least a portion of the breakaway bottom 210 can separate from the outer shell 206 and/or resist puncture by the brewing pin 126. In some examples, the breakaway bottom 210 can include an alternate material that may reinforce the breakaway bottom 210 and resist puncture via the brewing pin 126. In at least one example, the breakaway bottom 210 can be comprised of PLA, which can be the same material as the outer shell 206. In some examples, the breakaway bottom 210 can be at least 2 millimeter thick. An increased thickness in the breakaway bottom 210 in relation to the rest of the outer shell 206 can help the breakaway bottom 210 resist puncture by the brewing pin 126. In some examples, the breakaway bottom 210 and/or at least a portion of the outer shell 206 can be annealed to strengthen the breakaway bottom 210 and/or at least a portion of the outer shell 206 to resist puncture by the brewing pin 126. The breakaway bottom 210 can be annealed after the part has been formed. The breakaway bottom 210 can be reheated to a higher temperature, for example greater than 90 degrees Celsius, alternatively between 90 degrees Celsius and 175 degrees Celsius. This can change the crystal structure of material and improve mechanical properties. In some examples, at least a portion of the outer shell 206 can be annealed. In some examples, only the breakaway bottom 210 can be annealed by pinpointing the breakaway bottom 210. For example, the breakaway bottom 210 can be pinpointed for annealing by ultrasonic means.

The break portion 208 can be operable rupture, tear, and/or break upon being exposed to a threshold force. For example, the brewing pin 126 may push against the breakaway bottom 210, and as the breakaway bottom 210 resists puncture by the brewing pin 126, the force from brewing pin 126 exceeds the threshold force for the break portion 208. At least a portion of the break portion 208 then breaks upon receiving the threshold force enacted upon the breakaway bottom 210 by the brewing pin 126. Accordingly, at least a portion of the breakaway bottom 210 attached to the portion of the break portion 208 that breaks separates from the outer shell 206. In at least one example, the break portion 208 can be thinner (e.g., lesser thickness) in relation to the outer shell 206 and the breakaway portion 210. The break portion 208 can have a thickness such that the break portion 208 does not break until the threshold force is imparted upon the break portion 208 by the brewing pin 126. In some examples, the break portion 208 may include perforations. In some examples, the break portion 208 can include an adhesive.

In some examples, the separation of the portion of the breakaway bottom 210 from the outer shell 206 opens up a receiving portion 240. The beverage can pass through the filter 212 into the receiving portion 240 and out of the outlet 220. In some examples, the outlet 220 can include the brewing pin 126. In some examples, the outlet 220 can be the receiving portion 240 as the receiving portion 240 creates a void between the breakaway bottom 210 and the outer shell 206. The void of the outlet 220 can be a larger passage than the brewing pin 126. The beverage can then pass through the void of the outlet 220 in greater volume and/or rate than via the brewing pin 126. A larger outlet 220 can increase the beverage extraction from the beverage pod 200.

In some examples, the breakaway bottom 210 can be movable within the bottom of the beverage pod 200 such that the breakaway bottom 210 is operable to displace at least a portion of the filter 212 when contacted by the brewing pin 126. For example, the brewing pin 126 may abut against the breakaway bottom 210. The breakaway bottom 210 resists puncture by the brewing pin 126, and at least a portion of the breakaway bottom 210 separates from the outer shell 206. The portion of the breakaway portion 210 is then pushed by the brewing pin 126 upwards (e.g., away from the bottom lid 216 and/or towards the lid 202). In some examples, the breakaway bottom 210 may abut against the filter 212 and push at least a portion of the filter 212 upwards to compress the chamber 230.

In some examples, as illustrated in FIGS. 2 and 3, the breakaway bottom 210 may be disposed in a receiving portion 230 disposed between the filter 212 and a bottom lid 216. As the breakaway bottom 210 is pushed by the brewing pin 126 and displaces at least a portion of the filter 212, the receiving portion 230 is expanded. Accordingly, the beverage can flow through the filter 212 into the receiving portion 230 and out of the beverage pod 200 via an outlet 220.

In some examples, the breakaway bottom 210 may be the bottommost portion of the beverage pod 210 as the breakaway bottom 210 is a portion of the outer shell 206. As at least a portion of the breakaway bottom 210 separates from the outer shell 206

In some examples, the breakaway bottom 210 may be an optional second layer comprised of the same materials as the outer shell, or it may be comprised of an additional material. In some examples, the outer shell 206 can be comprised of PLA and the breakaway bottom 210 can be comprised of a cellulose fiber which are bonded at the break portion 208, for example with an adhesive.

In some examples, the breakaway bottom 210 may completely detach from the outer shell 206 such that the breakaway bottom 210 is pushed by the brewing pin 126 into the beverage pod 200. However, the breakaway bottom 210 should stay within the beverage pod 200 such that the breakaway portion 210 does not fall into the beverage brewing machine 10. If the breakaway portion 210 falls into the beverage brewing machine 10, it may prevent the beverage brewing machine 10 from functioning as desired.

In some examples, only a portion of the breakaway bottom 210 may separate from the outer shell 206. In at least one example, the breakaway bottom 210 may include a hinge 218 which is operable to not break and keep a portion of the breakaway bottom 210 connected to the outer shell 206.

The hinge 218 can be a region of a breakaway bottom 210 designed to deform but not separate when contacted by an outlet brewing pin 126. In at least one example, the hinge 218 may be comprised of the same material as the breakaway bottom 210. In some examples, the breakaway bottom 210 can be thinned at the hinge 218 to allow a controlled failure or deformation of the hinge 218. Accordingly, the breakaway bottom 210 can bend and/or rotate about the axis of the hinge 218. The hinge 218 may divide the breakaway bottom 210 into one or more segments and/or may be a portion of the boundary between the breakaway bottom 210 and the outer shell 206. In at least one example, the hinge 218 can be a portion of the breakaway bottom 210 which remains attached to the outer shell 206. In some examples, there may be no hinge 218, as the breakaway bottom 210 may fully detach from the outer shell 206. In some examples, all exterior portions of the breakaway bottom 210 may function as a hinge 218, wherein a central portion of the breakaway bottom 210 is operable to break away from the outer shell 206, such that at least one of two halves of the breakaway bottom 210 may fold inward from the center.

The brewing pin 126 is a piercing element designed to breach the bottom of a beverage pod 200 to allow the brewed beverage to leave the beverage pod 200. The brewing pin 126 may further comprise a channel through which the brewed beverage may flow after the brewing pin 126 has breached the bottom of the beverage pod 200. In at least one example, the brewing pin 126 does not pierce the bottom of the beverage pod 200, but instead contacts the breakaway bottom 210 which forms the bottom of the beverage pod 200. The breakaway bottom 210 is then operable to partially or completely separate from the outer shell 206 along a break portion 218 or otherwise deforming around the brewing pin 126 such that the breakaway bottom 210. The breakaway portion 210 can prevent the brewing pin 126 from compromising the integrity and function of the filter 212 while also creating an outlet 220 for the brewed beverage to exit the beverage pod 200.

In at least one example, the beverage pod 200 can include a bottom lid 216 coupled to the outer shell 206. The bottom lid 216 of the beverage pod 200 can be optionally arranged such that it is attached to the bottom of a beverage pod 200. The bottom lid 216 can be connected to the outer shell 206, for example via a pod bond 204, and can allow the beverage pod 200 to be a sealed unit to prevent fluid to pass into or out of the beverage pod 200. In at least one example, the bottom lid 216 can include a PLA, cellulose film, or combinations thereof. The bottom lid 216 can assist in controlling the flow of the beverage after the breakaway bottom 210 has been breached by the brewing pin 126.

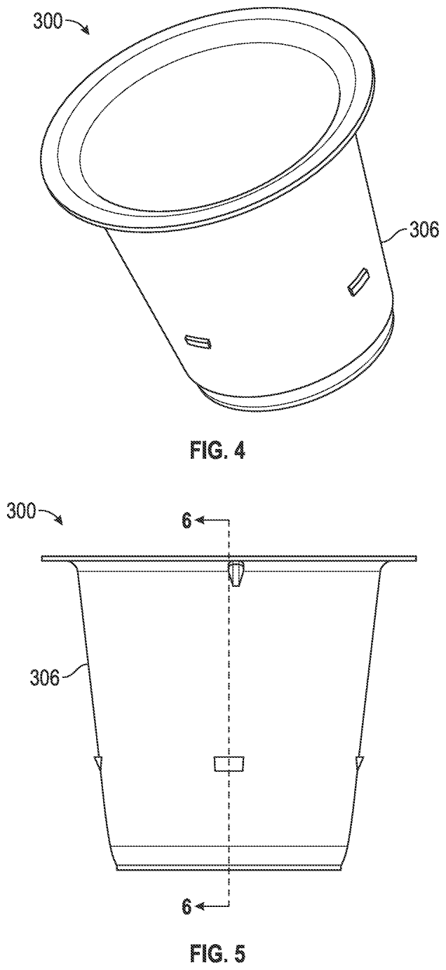

FIGS. 4-9 illustrate the beverage pod 300 with the outer shell 306 having an example of a breakaway bottom 310. The outer shell 306 can be made of plastic (for example compostable plastic, such as PLA, PHA, or combinations thereof), cellulose, etc. The outer shell 306 can have similar properties to other thermoplastic polymers such as polypropylene (PP), polyethylene (PE), or polystyrene (PS). This allows it to serve as a biodegradable alternative for coffee pods. The outer shell 306 can also be made from polyhydroxyalkanoates (PHAs), which are a biodegradable polyester produced through bacterial fermentation of sugar or lipids. They can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage cartridge. PLLA is also readily renewable, typically made from fermented plant starch such as from corn, cassava, sugarcane or sugar beet pulp. Cellulose fibers are fibrous materials made from plant materials such cotton, flax, wood pulp, etc. They provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH) and Polybutylene adipate terephthalate (PBAT).

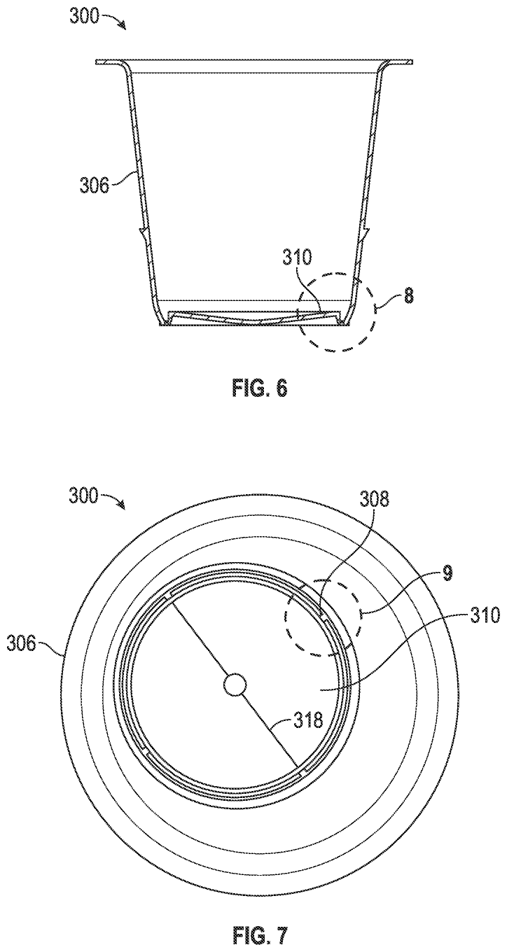

Thermoplastic materials can be formed via a process of vacuum forming wherein the plastic material is heated and then pulled over a form and applying a vacuum through the form so that the plastic material is pressed around the form by the ambient air pressure. Alternatively, thermoplastics may be injected into a mold via injection molding. Forming of non-plastic materials such as fibers can be formed in a pressure mold. Heat may additionally be applied to aid drying. In at least one example, as illustrated in FIGS. 4-9, the outer shell 306 can include PLA and can be formed via vacuum forming over a form in the shape of the negative space within the beverage pod 300. FIG. 6 illustrates a cutaway view of FIG. 5 and shows the interior profile of the beverage pod 300. The outer shell 306 is shown including the breakaway bottom 310 located at the bottom of the beverage pod 300. The break portion 308, as shown in FIGS. 7-9, is the boundary between the outer shell 306 and the breakaway bottom 310. The breakaway bottom 310 is a structure integrated into a beverage pod 300 that can prevent the brewing pin 126 from tearing or rupturing the filter and creating a path for the insoluble beverage material to escape through the outlet. Additionally, the breakaway bottom 310 can create a large outlet where the breakaway bottom 310 separates from the outer shell 306 to increase and/or improve beverage extraction.

The breakaway bottom 310 provided herein is a breakaway feature integrated into the outer shell 306. In some example, the breakaway bottom 310 and the outer shell 306 can be one piece. In some examples, the breakaway bottom 310 may be affixed to the outer shell 306 via a pod bond, held in place by other pod structures, or be affixed to the outer shell 306 via a break portion 318. The breakaway bottom 310 may be comprised of the same material as the outer shell 306 or an alternate material that may be more rigid and therefore puncture resistant. In at least one example, the breakaway bottom 310 and the outer shell 306 can both be comprised of PLA. In some examples, the breakaway bottom 310 has a thickness greater than the thickness of the outer shell. In some examples, the breakaway bottom 310 and the outer shell 306 have the same thickness. In some examples, the breakaway bottom 310 is at least 2 millimeters thick.

In some examples, the breakaway bottom 310 is movable within the bottom of the beverage pod 300 located between the filter and the outer shell 306. In some examples, the breakaway bottom 310 may completely separate from the outer shell 306. In some examples, as illustrated in FIGS. 6-9, the breakaway bottom 310 may be connected to the outer shell 306 via a hinge 318. The breakaway bottom 310 may rotate about the hinge 318 comprised of the outer shell 306 or an unmoving part of the breakaway bottom 310, such that the portion of the breakaway bottom 310 that separates from the outer shell 306 displaces the filter when the breakaway bottom 310 is contacted by the brewing pin 126.

FIG. 7 illustrates a top view of the beverage pod 300 and shows the interior of the beverage pod 300 from above without a lid. The bottom of the beverage pod 300 features the breakaway bottom 310 which interfaces with the outer shell 306 at the break portion 308. The hinge 318, as illustrated in FIG. 7, is located in the center of the breakaway bottom 310. In at least one example, the breakaway bottom 310 can be bisected by the hinge 318 which divides the breakaway bottom 310 into two sections. The break portion 308 may be the boundary between the outer shell 306 and the breakaway bottom 310 which serves as a fracture point when a threshold force is applied to the breakaway bottom 310 by the brewing pin 126 of the beverage brewing machine. The outer shell 306 and breakaway bottom 310 may be formed in the same process from the same material wherein the breakaway is formed by perforations or a thinning of the plastic along the breakaway. In some examples, the outer shell 306 and breakaway bottom 310 may be formed separately, and the breakaway comprised of a chemical or thermal bond such as an adhesive or a heating of one or both materials such that the two pieces become bonded to one another.

In some examples, the break portion 308 may include the entirety of the perimeter of the breakaway bottom 310. In some examples, the break portion 308 may comprise less than the entirety of the perimeter of the breakaway bottom 310 such that the breakaway bottom 310 will remain attached to the outer shell 306 at a hinge 318 when a force is applied to the breakaway bottom 310 by the brewing pin 126 of the beverage brewing machine. In some examples, the break portion 308 and/or hinge 318 can be located along the diameter of the bottom of the beverage pod 300.

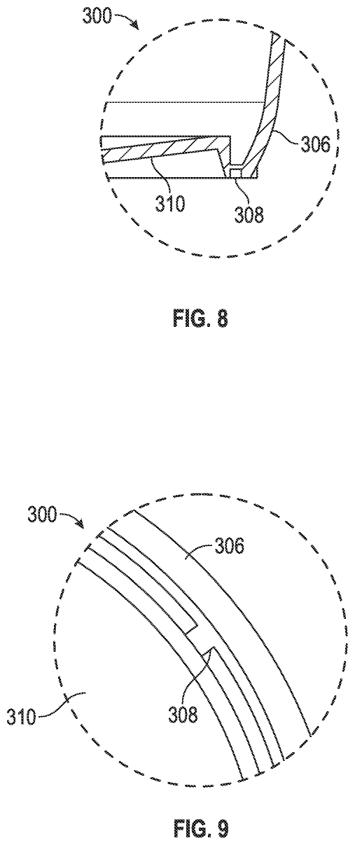

In some examples, the outer shell 306 and breakaway bottom 310 can be formed simultaneously by vacuum forming a thermoplastic such as PLA and applying pressure from a second form to the opposite side of the thermoplastic from the form wherein the second form matches the perimeter of the breakaway bottom 310 formed by the break portion 308. The pressure from the second form can cause the thermoplastic to thin such that it is physically weaker than the outer shell 306 and the filter, as shown in FIG. 8. The hinge 318 can be a boundary between the movable portion of the breakaway bottom 310 and an immovable part of the breakaway bottom 310 or outer shell 306 creating an axis of rotation and/or pivot.

In at least one example, the hinge 318 bisects the breakaway bottom 310 creating two sections. The portion of the breakaway bottom 310 that is contacted by the brewing pin 126 separates from the outer shell 306 at the break portion 308 and is rotated and/or pivoted about the hinge 318 in an upward direction (e.g., towards the lid). In at least one example, the breakaway bottom 310 can deflect and/or displace at least a portion of the filter. In some examples, a portion of the breakaway bottom 310 not in contact with the brewing pin 126 can remain affixed to the outer shell 306. The hinge 318 may further be made of the same material as the breakaway bottom 310 but may be thinner than the rest of the breakaway bottom 310. In some examples, the hinge 318 may be thicker than the break portion 308 to prevent failure of the breakaway bottom 310. In some examples, the hinge 318 can be an intersection of the breakaway bottom 310 and the outer shell 306. When a portion of the breakaway bottom 310 is contacted by the brewing pin 126, the breakaway bottom 310 can be made to separate from the outer shell 306 at the break portion 308 and rotate upward about the hinge 318. In some examples, only the portion of the breakaway bottom 310 contacting the brewing pin 126 is forced upward, while the remaining portions of the breakaway bottom 310 remain affixed to the outer shell 306. The hinge 318 is not required in all examples and may be absent in such examples that allow complete separation of the breakaway bottom 310 from the outer shell 306.

FIG. 8 illustrates an enlarged view of a portion 8 of FIG. 6 and shows the break portion 308 as a narrow connection between the breakaway bottom 310 and the outer shell 306. As illustrated, the break portion 308 is an interface of the same material as the outer shell 306 and the breakaway bottom 310 which is substantially thinner than both the breakaway bottom 310 and the outer shell 306. In the illustrated examples, the breakaway bottom 310 can slope upward from the center of the beverage pod 300 and, in some examples, can angle downward before meeting the outer shell 306 at the break portion 308. This may allow the breakaway bottom 310 to capture the brewing pin 126 to prevent the brewing pin 126 from slipping past the breakaway bottom 310 and contacting the filter. The breakaway bottom 310 may alternatively have ridges, dimples, facets or a grid of features such as to capture the outlet pin to prevent it from slipping past the breakaway bottom 310.

FIG. 9 illustrates an enlarged view of a portion 7 of FIG. 7 and shows the break portion 308 as a tab connecting the breakaway bottom 310 to the outer shell 306. As illustrated, the break portion 308 is an interface of the same material as the outer shell 306 and the breakaway bottom 310, however the amount of material is significantly reduced. The tabs may be thinner than the outer shell 306 and breakaway bottom 310. Alternatively, the tabs may be replaced by perforations along the breakaway between the outer shell 306 and the breakaway bottom 310. In examples where missing material via perforations or the use of tabs prevents the beverage pod 300 from being a sealed unit, a bottom lid may be used to create a seal. This bottom lid may be comprised of the same material and have similar properties as the lid and be similarly affixed to the outer shell 306 by a pod bond.

With the breakaway bottom 310 protecting the filter from the brewing pin 126 as well as opening up an outlet, the chamber formed by the filter can then be substantially the entirety of the inside of the beverage pod 300. Accordingly, more beverage material can be disposed in the beverage pod 300 which can improve the beverage created.

The beverage pod 300 may be manufactured by an exemplary process to form the breakaway bottom 310. The process can begin with forming the pod by heating the pod material and applying the material to a form. In at least one example, the pod material comprising a biodegradable thermoplastic such as PLA or PHA which may or may not include fibers of natural or composite materials and being formed via a process of vacuum forming around a form in the shape of the negative space of the beverage pod 300. The form may alternatively be in the shape of the exterior of the beverage pod 300. The pod 300 may alternatively be formed via injection molding wherein the heated thermoplastic material is injected into a mold whereupon cooling, it retains the shape of the mold. The pod 300 may also be comprised of natural or composite fibers which may be pressed into a mold.

In at least one example, the pod is comprised of PLA and is formed by vacuum forming a sheet of PLA over a conical cylinder form. The formed pod 300 further may have any excess plastic removed by a cutting instrument which may additionally be heated. In some examples, the beverage pod 300 can be formed by a process of injection molding. In some examples, the beverage pod 300 can be formed by a process of freeform injection molding.

The breakaway bottom 310 can be formed by heating the pod material and applying the material to a form. In at least one example, the pod material is the same as the outer shell 306 and is formed via a process of vacuum forming. In some examples, the breakaway bottom 310 is formed via a process of injection molding. In a further embodiment the breakaway bottom 310 is formed via a process of freeform injection molding. In an embodiment, the breakaway bottom 310 is formed during the formation of the beverage pod 300 as an integrated component of the beverage pod 300.

In at least one example, after being formed, the breakaway bottom 310 can be reinforced to resist puncture by the brewing pin 126. For example, the breakaway bottom 310 can be reinforce by an annealing process. During the annealing process, the breakaway bottom 310 can be reheated to a higher temperature. In at least one example, the breakaway bottom 310 can be reheated to a temperature greater than 90 degrees Celsius. In some examples, the breakaway bottom 310 can be reheated to a temperature between 90 degrees Celsius and 175 degrees Celsius. Accordingly, the crystal structure of the material for the breakaway bottom 310 can be manipulated to improve the mechanical properties of the breakaway bottom 310. In some examples, the entire outer shell 306 including the breakaway bottom 310 may be annealed. In some examples, only the breakaway bottom 310 may be annealed, for example by an ultrasonic process.

The breakaway bottom 310 may comprise a hinge 318 which can be comprised of the same material as the breakaway bottom 310. In at least one example, the hinge 318 can be made thinner such to allow the force of a beverage brewing machine brewing pin 126 to bend the breakaway bottom 310 at the hinge 318. In at least one example, the hinge 318 can be formed by heating the breakaway bottom 310 along the hinge 318 with a heating element and applying pressure to the hinge 318 until the plastic is thinner than the breakaway bottom 310, for example 50% of the thickness of the breakaway bottom 310.

In at least one example, the hinge 318 may bisect the breakaway bottom 310 and/or be located at a segment of the breakaway bottom 310 periphery. In at least one example, the hinge 318 may be formed when the breakaway bottom 310 is formed.

In some examples, the breakaway bottom 310 and/or the break portion 308 is formed during the formation of the outer shell 306. In such examples, the break portion 308 can be formed by weakening the boundary between the outer shell 306 and the breakaway bottom 310 by thinning, scoring, perforating or cutting along the boundary between the outer shell 306 and the breakaway bottom 310. Accordingly, the resulting break portion 308 is operable to separate when the force of the brewing pin 126 of a beverage brewing machine is applied to the breakaway bottom 310 without a failure of the beverage pod 300 elsewhere including any of the pod lid, outer shell 306, hinge 318, or breakaway bottom 310. In at least one example, the break portion 308 can be formed by a heating element in the shape of the break portion 308, which is applied to the boundary of the outer shell 306 and the breakaway bottom 31. The outer shell 306 and the breakaway bottom 310 can be formed simultaneously via a process of vacuum forming, and the resulting heat and pressure from the heating element can thin the pod material at the break portion 308 such that the break portion 308 has a lesser thickness than the breakaway bottom 310 and/or the outer shell 306, for example less than 50% the thickness of the breakaway bottom 310 and/or the outer shell 306.

In some examples, the break portion 308 can be formed by connecting the breakaway bottom 310 to the outer shell of the beverage pod 300 via a pod bond if the outer shell 306 and breakaway bottom 310 are formed independently. The pod bond may be formed using an adhesive or by heating the outer shell and breakaway bottom 310 material to fuse the material together. The pod bond formed to create a break portion 308 may be weaker than a pod bond used elsewhere in construction of the beverage pod 300, such as attaching the pod lid, as the break portion 308 is intended to separate with the force of a brewing pin 126.

The filter can then be installed. The filter can include a biodegradable material comprising any of PLA, PHA, natural or composite fiber, or a combination of two or more of these materials. In at least one example, PLA is heated until melted and is extruded through at least one hole in an extrusion die resulting in at least one strand of thin plastic which is deposited on a plate to cool. A layering of these extrusions, resulting in a mat of threads with a porosity size smaller than that of the grain size of the beverage material. In some examples, the beverage material is coffee grounds. The filter may be loosely placed within outer shell 306 of the beverage pod 300 and/or may be bonded to the beverage pod 300, such as by ultrasonic welding. With the breakaway bottom 310, the filter can substantially line the outer shell 306 from the lid to the breakaway bottom 310. Accordingly, more beverage material can be included in the enlarged chamber formed by the filter.

A desired amount of beverage material can be measured out and inserting the beverage material into the beverage pod 300. The beverage material may be soluble such as hot cocoa or sugar. In some examples, the beverage material may be insoluble such as coffee grounds or tea. In some examples, the beverage material can include 13 grams of coffee grounds which are inserted into the beverage pod 300. The beverage material may be measured prior to being inserted into the beverage pod 300 or may be measured while being added to the beverage pod 300 such as by measuring the changing weight of the beverage pod 300 as the beverage material is added.

A pod lid can be applied to the opening of the beverage pod 300 via a pod bond between the pod lid and the outer shell 306 to create a sealed beverage pod 300. The pod bond may be formed using heat or an adhesive, or a combination of heat and an adhesive to create a seal. The creating of a pod bond may be immediately preceded by the addition of a preservative, such as an inert gas to preserve the freshness of the beverage material. The addition of the preservative may alternately be added to the beverage pod 300 in a simultaneously with the application of the pod bond. In at least one example, the pod lid can include a biodegradable cellulose paper film which is affixed to the beverage pod 300 using an adhesive pod bond immediately following the addition of nitrogen gas to displace the air within the beverage pod 300, acting as a preservative to maintain freshness.

In some examples, the break portion 308 can be formed by creating perforations in the bottom of the beverage pod 300 at the boundary of the outer shell and the breakaway bottom 310. In some examples, to achieve a seal a bottom lid, similar to the pod lid, can be applied to the bottom of the beverage pod 300, via a pod bond between the bottom lid and the outer shell 306 to create a sealed unit beverage pod 300. In some examples, a bottom lid is not included.

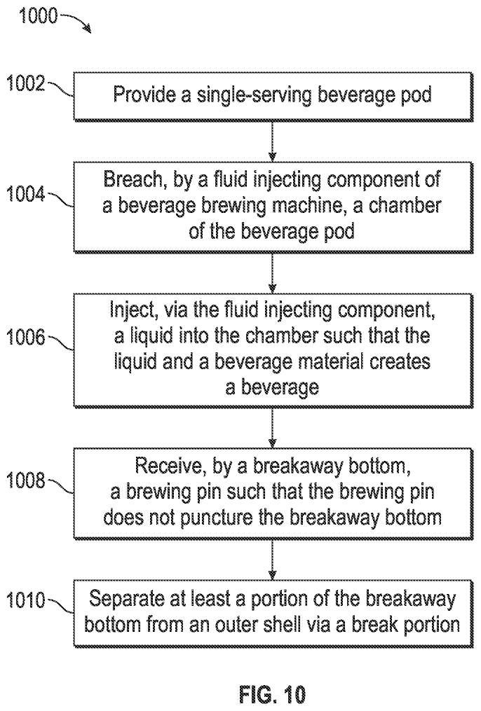

FIG. 10 is an example method 1000 for brewing a beverage with a beverage pod, in accordance with various aspects of the subject technology. The method 1000 is provided by way of example, as there are a variety of ways to carry out the method. The method 1000 described below can be carried out using the configurations illustrated in FIGS. 1A-9, for example, and various elements of these figures are referenced in explaining example method 1000. Each block shown in FIG. 10 represents one or more processes, methods or subroutines, carried out in the example method 1000. Furthermore, the illustrated order of blocks is illustrative only and the order of the blocks can change according to the present disclosure. Additional blocks may be added or fewer blocks may be utilized, without departing from this disclosure. The method 1000 can begin at block 1002.

At block 1002, a single-serving beverage pod is provided. The beverage pod can include a filter forming a chamber operable to contain a beverage material. The beverage material can be operable to mix with a liquid to form a beverage. The beverage pod can also include an outer shell including a breakaway bottom.

At block 1004, a fluid injecting component of a beverage brewing machine breaches a chamber of the beverage pod. At block 1006, a liquid is injected via the fluid injecting component into the chamber such that the liquid and a beverage material creates a beverage.

At block 1008, a breakaway bottom receives a brewing pin such that the brewing pin does not puncture the breakaway bottom. At block 1010, at least a portion of the breakaway bottom is separated from an outer shell via a break portion. In at least one example, upon separating the breakaway bottom from the outer shell, at least a portion of the filter can be displaced by the breakaway bottom. In some examples, upon separating the breakaway bottom from the outer shell and displacing at least a portion of the filter, a volume of a receiving portion operable to receive the beverage can be increased. In some examples, upon separating the breakaway bottom from the outer shell, an outlet can be formed through which the beverage exits the beverage pod. By creating a larger outlet than only via the brewing pin, the extraction of the beverage can be increased.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A beverage pod comprising:
a filter forming a chamber operable to contain a beverage material, the beverage material operable to mix with a liquid to form a beverage;
an outer shell including a breakaway bottom, the breakaway bottom operable to receive a brewing pin from a beverage brewing machine such that at least a portion of the breakaway bottom separates from the outer shell.

2. The beverage pod of claim 1, wherein the breakaway bottom, upon separating from the outer shell, is operable to abut against the filter and displace at least a portion of the filter.

3. The beverage pod of claim 2, wherein the breakaway bottom, upon separating from the outer shell and displacing at least a portion of the filter, increases a volume of a receiving portion operable to receive the beverage.

4. The beverage pod of claim 1, wherein the breakaway bottom, upon separating from the outer shell, forms an outlet through which the beverage exits the beverage pod.

5. The beverage pod of claim 1, wherein the breakaway bottom is operable to resist puncture by the brewing pin.

6. The beverage pod of claim 5, wherein the breakaway bottom has a thickness greater than a thickness of the outer shell.

7. The beverage pod of claim 6, wherein the breakaway bottom has a thickness greater than 2 millimeters.

8. The beverage pod of claim 5, wherein the breakaway bottom is annealed.

9. The beverage pod of claim 1, further comprising a bottom lid coupled to the outer shell operable to be breached by the brewing pin prior to the brewing pin abuts against the breakaway bottom.

10. The beverage pod of claim 1, wherein the outer shell includes a break portion, wherein at least a portion of the break portion is operable to break upon receiving a threshold force enacted upon the breakaway bottom by the brewing pin.

11. The beverage pod of claim 10, wherein the break portion includes perforations.

12. The beverage pod of claim 10, wherein the break portion includes adhesive.

13. The beverage pod of claim 10, wherein the break portion is thinner in relation to the outer shell and/or the breakaway bottom.

14. The beverage pod of claim 1, wherein the breakaway bottom includes a hinge.

15. The beverage pod of claim 14, wherein the hinge is located in the center of the breakaway bottom.

16. The beverage pod of claim 1, wherein the breakaway bottom and the outer shell are one piece.

17. A method comprising:
providing a single-serving beverage pod, the beverage pod including:
a filter forming a chamber operable to contain a beverage material, the beverage material operable to mix with a liquid to form a beverage;
an outer shell including a breakaway bottom;
breaching, by a fluid injecting component of a beverage brewing machine, the chamber;
injecting, via the fluid injecting component, a liquid into the chamber such that the liquid and the beverage material creates a beverage;
receiving, by the breakaway bottom, a brewing pin such that the brewing pin does not puncture the breakaway bottom; and
separating at least a portion of the breakaway bottom from the outer shell via a break portion.

18. The method of claim 17, further comprising:
upon separating the breakaway bottom from the outer shell, displacing at least a portion of the filter by the breakaway bottom.

19. The method of claim 18, further comprising:
upon separating the breakaway bottom from the outer shell and displacing at least a portion of the filter, increasing a volume of a receiving portion operable to receive the beverage.

20. The method of claim 17, further comprising:
upon separating the breakaway bottom from the outer shell, forming an outlet through which the beverage exits the beverage pod.
